(19) United States
(12) Patent Application Publication
(10) Pub. No.: US 2018/0128938 A1
(43) Pub. Date: May 10, 2018

(54) PREDICTION OF METHANE HYDRATE PRODUCTION PARAMETERS

(71) Applicants: Xiaowei Wang, Houston, TX (US); Terry Bussear, Spring, TX (US); Ian Ayling, Katy, TX (US)

(72) Inventors: Xiaowei Wang, Houston, TX (US); Terry Bussear, Spring, TX (US); Ian Ayling, Katy, TX (US)

(73) Assignee: Baker Hughes Incorporated, Houston, TX (US)

(21) Appl. No.: 15/345,007

(22) Filed: Nov. 7, 2016

(51) Int. Cl. G01V 99/00; E21B 47/06; E21B 43/12

(52) U.S. Cl. CPC G01V 99/005; E21B 47/06; E21B 2043/0115; E21B 43/122; E21B 47/065

(57) ABSTRACT

A system for predicting production parameters includes a production assembly configured to receive fluid from a region of an earth formation that includes a methane hydrate deposit, and a processor configured to receive data including a temperature and a pressure of the fluid, the processor configured to perform generating a mathematical model based on an energy balance relationship that includes an amount of energy estimated to be used by a dissociation reaction that produces dissociated water and dissociated gas, the energy balance relationship accounting for a first amount of energy taken by the dissociated water and a second amount of energy taken by the dissociated gas, the energy balance relationship based on the temperature of the fluid and the pressure of the fluid. The processor predicts a flow rate of the dissociated gas as a function of a pressure differential in the borehole based on the model.

### BACKGROUND

Methane hydrate is a clathrate compound in which water molecules freeze about methane and trap the methane molecules therein. Methane hydrate deposits are a potentially significant source of methane and thus of interest to the energy industry. Methane hydrate deposits typically form within relatively shallow formations in subsea and arctic locations due to the low temperatures needed to form such deposits. Recovery of methane from methane hydrate deposits involves reducing pressure in a formation to allow methane gas to dissociate from the hydrate. As methane hydrate production has specific pressure and temperature requirements, accurate assessment of downhole conditions is important to maintain production and prevent methane hydrate re-formation.

### SUMMARY

An embodiment of a system for predicting production parameters includes a production assembly configured to be disposed along a length of a borehole, the production assembly configured to receive fluid from a region of an earth formation that includes a methane hydrate deposit, the fluid including methane gas dissociated from the deposit and water dissociated from the deposit. The system also includes a processor configured to receive data including a temperature and a pressure of the fluid, the processor configured to perform generating a mathematical model based on an energy balance relationship that includes an amount of energy estimated to be used by a dissociation reaction that produces dissociated water and dissociated gas, the energy balance relationship accounting for a first amount of energy taken by the dissociated water and a second amount of energy taken by the dissociated gas, the energy balance relationship based on the temperature of the fluid and the pressure of the fluid. The processor is also configured to perform predicting a flow rate of the dissociated gas as a function of a pressure differential in the borehole based on the model.

An embodiment of a method of predicting production parameters includes receiving data related to a methane production operation, the data including a temperature and a pressure of fluid entering a borehole from a methane hydrate deposit, the fluid including methane gas dissociated from the deposit and water dissociated from the deposit. The method also includes generating, by a processor, a mathematical model based on an energy balance relationship that includes an amount of energy estimated to be used by a dissociation reaction that produces dissociated water and dissociated gas, the energy balance relationship accounting for a first amount of energy taken by the dissociated water and a second amount of energy taken by the dissociated gas, the energy balance relationship based on the temperature of the fluid and the pressure of the fluid. The method further includes predicting a flow rate of the dissociated gas as a function of a pressure differential in the borehole based on the model, and selecting an operational parameter based on the predicted flow rate.

### BRIEF DESCRIPTION OF THE DRAWINGS

The following descriptions should not be considered limiting in any way. With reference to the accompanying drawings, like elements are numbered alike:

FIG. 1 depicts an embodiment of a methane hydrate production system;

FIG. 2 is a pressure vs temperature plot showing aspects of methane hydrate dissociation and production.

FIG. 3 is a pressure vs temperature plot that illustrates effects of different downhole pressures on production from methane hydrates;

FIG. 4 illustrates phenomena that contribute to fluid flows and heat sources in a formation having a methane hydrate deposit during production;

FIG. 5 depicts an example of flow rates of dissociated methane gas and water predicted according to embodiments described herein;

FIG. 6 depicts an example of temperatures of dissociated methane gas and water predicted according to embodiments described herein; and

FIG. 7 depicts an example of a measured borehole temperature distribution.

### DETAILED DESCRIPTION OF THE INVENTION

Apparatuses, systems and methods are provided for evaluating, planning, monitoring and/or performing production of methane gas from earth formations. An embodiment of a processing system includes a processor configured to receive borehole fluid parameter data including temperature and pressure, and predict conditions under which a subsurface methane hydrate deposit may be expected to respond as a result of depressurization-induced production. The prediction may include separately estimating the borehole entrance temperature for water and methane gas, and also estimating production rates of both water and methane gas as a function of dynamic downhole pressure conditions (e.g., bottomhole pressure conditions and/or pressure conditions at one or more production zones). In one embodiment, the system performs dynamic modeling of dissociation and production of methane from methane hydrates based on an estimation of heat or energy required by the methane hydrate dissociation reaction and an energy balance relationship. The energy balance accounts for individual energy or heat contributions from free water, dissociated water, dissociated gas and external factors. In one embodiment, the model accounts for different temperatures of dissociated water and gas based on calculation of the Joule-Thomson effect.

Typically there is an absence of a priori knowledge of the quality and volume of a methane hydrate deposit, which can compromise the effectiveness of exploration and production. Embodiments described herein uniquely enable effective design of a methane hydrate production system by predicting the dynamic range of drawdown pressure required, and the likelihood and locations of methane hydrate reformation (plugging) within the complete production system. In addition, the embodiments described herein allow for continuous or near continuous updating of free water production, gas production and gas/water temperature, which ensures avoidance of reformation within the system and can optimize pressure drawdown parameters.

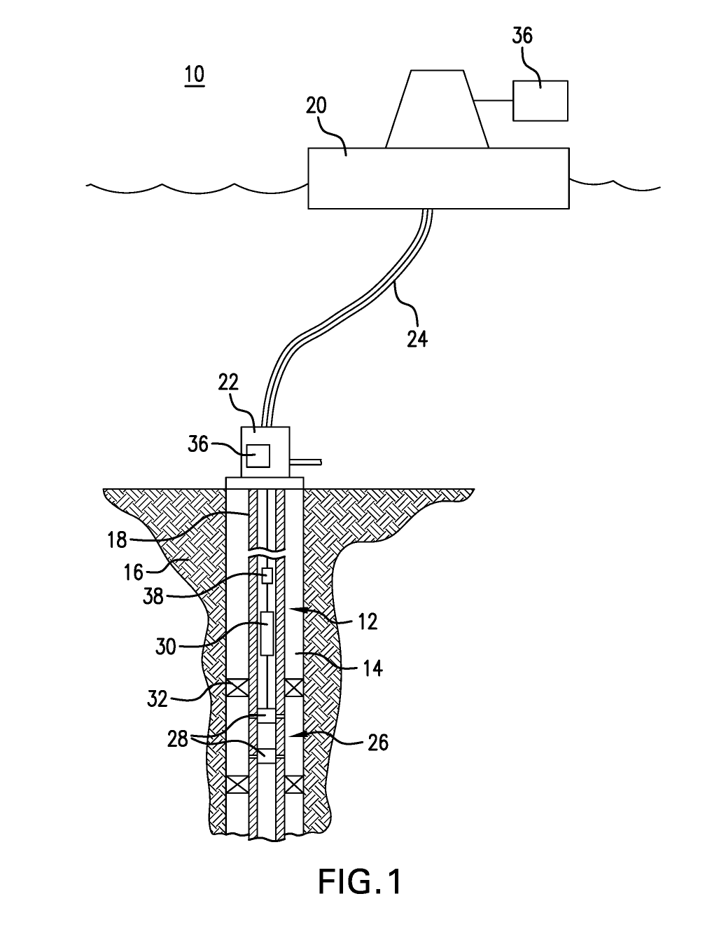

Referring to FIG. 1, an exemplary embodiment of a hydrocarbon production stimulation system 10 includes a borehole string 12 configured to be disposed in a borehole 14 that penetrates at least one earth formation 16. The borehole may be an open hole, a cased hole or a partially cased hole. In one embodiment, the borehole string 12 is a production string that includes a tubular 18, such as a pipe (e.g., multiple pipe segments) or coiled tubing, that extends from a wellhead at a surface location (e.g., at a drill site or as part of an offshore system). A “borehole string” as described herein may refer to any structure suitable for being lowered into a wellbore or for connecting a drill or downhole tool to the surface, and is not limited to the structure and configuration described herein. For example, the borehole string may be configured as a wireline tool, coiled tubing, a drillstring or a LWD string.

In one embodiment, the system 10 is configured to perform energy industry operations in a subsea environment, i.e., an environment where an earth formation is located under a body of water. For example, the system 10 includes a surface facility 20 such as one or more platforms and/or marine vessels. The surface facility 20 is connected to a subsea wellhead 22 that includes components for transmitting power and communications between the surface facility 20 and downhole and/or subsea surface components. The wellhead 22, downhole components and/or subsea components are connected to the surface facility 20 via one or more risers 24. The riser 24 may include or be incorporated as a communication and/or production riser or conduit. Although embodiments are described herein in the context of subsea systems, they are not so limited. The devices, systems and methods described herein may be incorporated in land-based systems and operations.

The system 10 includes one or more downhole components and/or tools for performing or facilitating various energy industry operations, such as drilling, measurement and production operations. For example, the system 10 is or includes a methane production system configured to produce methane from methane hydrate deposits in the formation 16. In this example, the system 10 includes one or more production and/or injection assemblies 26 configured to control production or downhole parameters related to production. Each production assembly 26 includes one or more injection or flow control devices 28 (e.g., hydraulic sleeves or valves) configured to control fluid (e.g., gas, oil and water) entering the borehole and/or control injection of fluids into the formation. The flow control devices 28 may be any suitable structure or configuration capable of injecting or flowing stimulation fluid from the borehole string 12 and/or tubular 18 to the borehole. Exemplary flow control devices include flow apertures, flow input or jet valves, injection nozzles, sliding sleeves and perforations.

In one embodiment, the system 10 is configured to produce methane from methane hydrates in the formation. Production of free methane from methane hydrates in a formation region is based on reducing or otherwise controlling pressure in the region to initiate and maintain a dissociation reaction in which methane is released from the hydrate. Continuous dissociation and hence production depends on maintenance of the energy balance at dissociation conditions within the reservoir and throughout the traverse within the wellbore and through the production train to the surface.

The system 10 and the production assemblies may include various components to facilitate release of methane and transmission of methane to the surface. For example, a pumping device such as an electric submersible pump (ESP) 30 is disposed with the borehole string 12 to control pressure downhole and/or pump fluids to the surface. One or more production zones may be established via, e.g., one or more packers 32. Other components may be included for, e.g., injection of fluids such as hot water or carbon dioxide to facilitate freeing methane from the hydrate.

Various sensors or sensing assemblies may be disposed in the system to measure downhole parameters and conditions. For example, pressure and/or temperature sensors may be disposed at the production string at one or more locations (e.g., at or near flow control devices 28). Such sensors may be configured as discrete sensors such as pressure/temperature sensors or distributed sensors. An exemplary distributed sensor is a Distributed Temperature Sensor (DTS) assembly that is disposed along a selected length of the borehole string 12. The DTS assembly is configured to measure temperature continuously or intermittently along a selected length of the string 12, and includes at least one optical fiber that extends along the string 12, e.g., on an outside surface of the string or the tubular 18. Temperature measurements collected via the DTS assembly can be used in a model and/or simulation to estimate or predict production parameters as discussed further below.

In one embodiment, the DTS assembly, the ESP 30, the production assemblies 26, and/or other components are in communication with one or more processors, such as a surface processing unit 36 and/or a downhole electronics unit 38. The communication incorporates any of various transmission media and connections, such as wired connections, fiber optic connections and wireless connections. The surface processing unit 36, electronics unit 38 and/or the production assembly 26 include components as necessary to provide for storing and/or processing data collected from various sensors therein. Exemplary components include, without limitation, at least one processor, storage, memory, input devices, output devices and the like. For example, the surface processing unit includes a processor and a memory, and is configured to execute software for processing measurements and generating a model as described below.

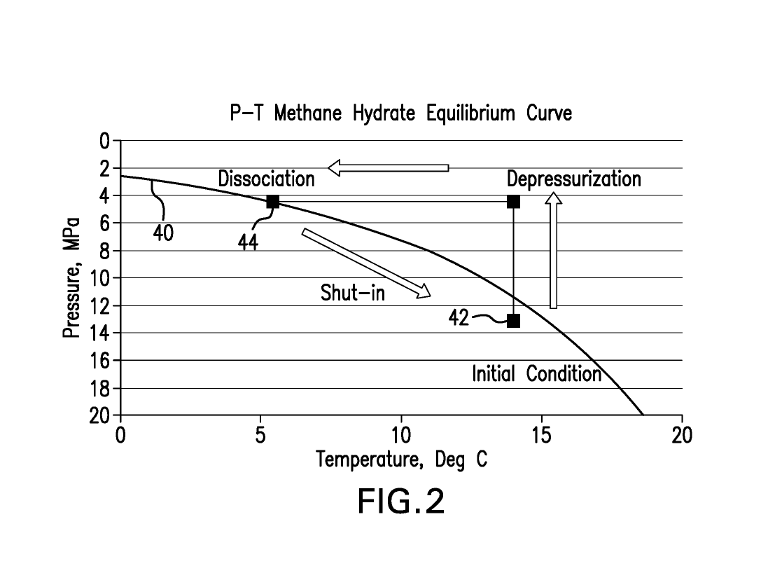

FIG. 2 is a pressure-temperature methane hydrate equilibrium curve plot. A pressure-temperature (P-T) methane hydrate equilibrium curve 40 represents the temperature during the dissociation process at given pressure. (similar to at ltm, water at 100 deg C, what will take energy to vapor, during the vaporing process, the temperature will stay at 100 deg C until all water becomes vapor) For example, at pressure 13 Mpa, the temperature will be at 16 deg C during the dissociation process At initial condition 42, the pressure is about 13 MPa and the temperature is about 14 deg C, which is lower than the required equilibrium temperature of about 16 deg C, thus no dissociation process can start. The borehole or a selected production zone is depressurized via a pressure drawdown to about 4 MPa (condition 44). At this pressure, the dissociation reaction occurs at a temperature of about 5 deg C and methane is released. During the dissociation process, the temperature is maintained at about 5 deg C. In order to initiate and maintain the dissociation reaction, the downhole pressure is maintained at a level or within a range so that the combination of downhole pressure and temperature allows the dissociation reaction to continue.

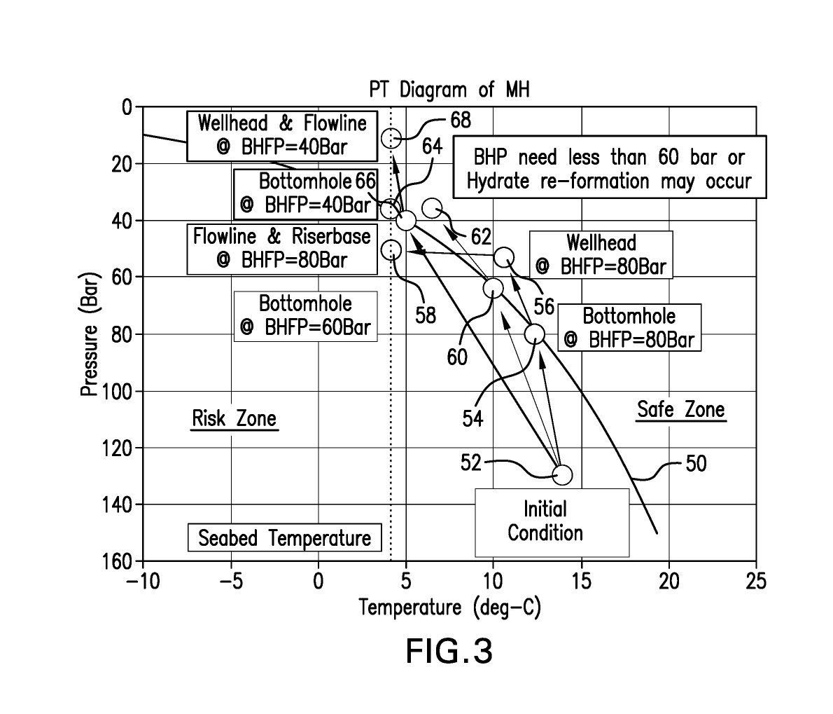

FIG. 3 depicts an example of a P-T methane hydrate equilibrium curve 50 and shows examples of pressures at various locations along the production system and their effect on methane production. In these examples, the surface (seabed) temperature is about 4 deg C. The curve 50 defines a boundary between a “safe zone” (the right hand side of curve) and a “risk zone” (the left hand side of curve). The safe zone defines conditions where the temperature is higher than the methane hydrate equilibrium temperature at a given pressure, and the risk zone defines conditions where the temperature is lower than the methane hydrate equilibrium temperature at a given pressure. Under conditions falling in the risk zone, hydrate re-formation (also referred to as plugging) occurs.

FIG. 3 also shows the effects of using different flow pressures of fluids circulated through the borehole. At the depth of a methane hydrate region, an initial condition 52 is shown. If the bottomhole pressure is reduced to 80 bar (point 54), the reduction of pressure in the wellhead (point 56) and the flowline or riser base (point 58) to the left side of the P-T methane hydrate equilibrium curve 50 results in conditions being in the risk zone. Likewise, if the bottomhole pressure is reduced to 60 bar (point 60), the reduction of pressure in the wellhead (point 62) and the flowline or riser base (point 64) on the P-T methane hydrate equilibrium curve 50 results in conditions being at the boundary of the risk zone. However, if the bottomhole pressure is reduced to 40 bar (point 66), the reduction of pressure in the wellhead and the flowline or riser base (point 68) results in conditions being in the safe zone. As shown in this example, the bottomhole pressure should be maintained at about 60 bar or less to avoid hydrate re-formation, and preferably should be maintained at about 40 bar to ensure that pressures and temperatures stay within the safe zone and avoid causing re-formation. It is noted that “bottomhole pressure” may refer to pressure at the bottom of a borehole or at any other borehole interval proximate to or corresponding to a formation region having a methane hydrate deposit (e.g., a production zone or production interval). The methane hydrate equilibrium curve changes as other conditions (including for example, borehole location, water depth (in offshore operations) and reservoir condition) changes.

The system 10 is configured to monitor production parameters and predict conditions that can have an effect on production of methane from methane hydrates. A processing device (e.g., the surface processing unit) is configured to perform simulations of the borehole and formation region around a production zone using a mathematical model of fluid flow and energy balance. The simulations and/or model may be used to predict parameters including temperature and/or flow rate (e.g., water and methane) as a function of downhole pressure (e.g., the bottomhole pressure or pressure at one or more production zones). The model accounts for a number of phenomena that occur downhole during production, and is effective in predicting downhole conditions and determining whether such conditions are conducive to production of methane. The model may be able to handle multiple production zones, each with its own zonal properties and is applicable for operations in both onshore and offshore environments.

The model takes into account phenomena including heat or energy required to initiate and maintain dissociation of water and methane in methane hydrates, which can occur when the region of the methane hydrate is exposed to sufficiently low pressures. The processing device receives or calculates the total energy absorbed by the dissociation reaction, and predicts temperature and flow rate of dissociated gas and water based on an energy balance equation that describes the energy balance between heat sources in the formation and the dissociation reaction. In one embodiment, reservoir inflow performance data (e.g., production index values) and estimation of the Joule-Thomson effect is used to estimate aspects of the energy balance. The model allows for accurate accounting of the above phenomena in order to get an accurate picture of downhole conditions, as changes in downhole conditions can have a significant impact on production. Based on this accurate picture, production parameters such as pressure drawdown and flow rate can be adjusted or otherwise controlled to maintain downhole pressures within a safe zone and increase and/or optimize production rates.

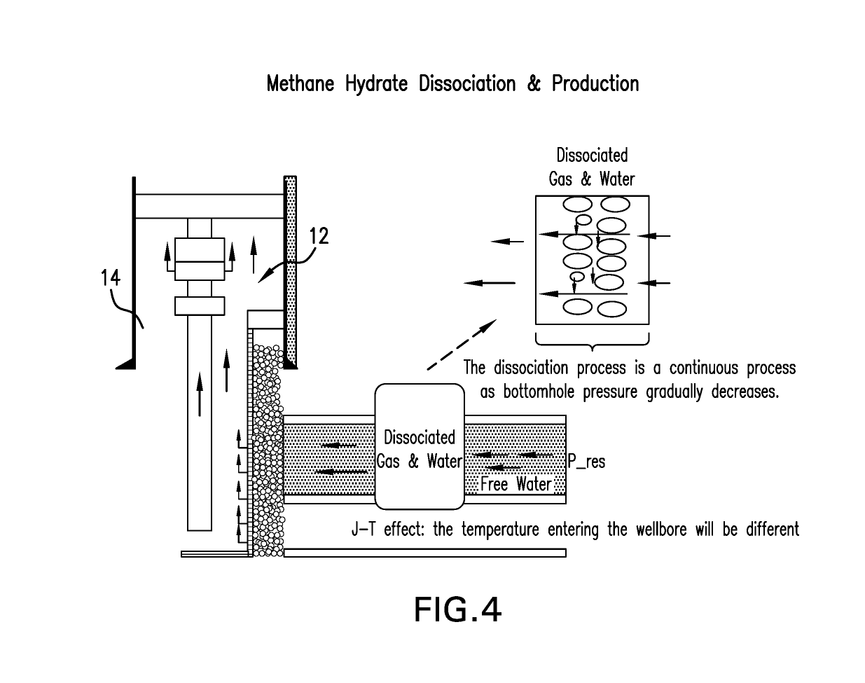

FIG. 4 illustrates an example of phenomena that occur during methane hydrate production and are accounted for by embodiments described herein. As shown in FIG. 4, when the borehole 12 enters a methane hydrate region, pressure decreases and methane and water in the hydrate dissociate and enter the borehole 12 as dissociated water and dissociated gas. Free water in the formation may also enter the borehole, thus the borehole fluid is a mixture of at least the dissociated gas, the dissociated water and the free water. The dissociation process is a continuous process that progresses as pressure gradually decreases in the formation. The temperature of fluid entering the borehole is not constant, but changes based on contributions from the dissociated gas, the dissociated water, and free water, each of which can have different temperatures and thus present different contributions to the measured temperature of borehole fluid.

Parameters input to the energy balance model include pressure and temperature measurements or estimates, as well as inflow performance data such as a production index. The processing device, using the energy balance model as part of a fluid flow simulation, performs a quantitative analysis method that includes calculating the heat balance between the dissociation reaction and a formation region. The method includes a correlation of phenomena related to the dissociation reaction, energy balance interactions, water flow rates and the Joule-Thomson effect as discussed further below. The correlation described herein permits prediction of water and methane production rates under dynamic conditions, e.g., under conditions in which the bottomhole or downhole pressure can change significantly during production. The method is able to account for the complex thermal interactions between downhole fluids and materials that result from the dissociation reaction and changes in inflow performance, temperature, pressure and flow rate.

In one embodiment, the correlation represents a separate calculation and consideration of the different phenomena, e.g., the dissociation process and the Joule-Thomson effect. This allows for an accurate estimate or prediction of the temperature of both water and gas. Conventionally, it is assumed that once the dissociation ends, then the temperature of the gas and water should be the same. However, in reality the temperature of the gas and water may not be the same. Individual consideration of the dissociation reaction and the Joule-Thomson effect predicts the potentially different temperature contributions of gas and water and thereby provides more accurate temperature predictions.

Prediction of water and gas temperatures and flow rates includes calculation of an energy balance equation that forms part of the model. The energy balance equation describes the heat exchange among the formation, free water, dissociated water and dissociated gas. The energy balance equation describes the amount of heat needed to maintain the dissociation reaction (heat absorbed by the dissociation reaction and the contribution of energy provided by the formation, free water, dissociated water and dissociated gas). The energy balance equation can be represented by:

Total Energy Absorbed=Energy provided by free water+Energy provided by dissociated water+Energy provided by dissociated gas+External energy.

The energy balance equation can also be represented in terms of the total heat needed by the reaction:

Total Heat=Free water taken energy+dissociated gas taken energy+dissociated water taken energy+external energy.

The model takes into account heat exchange between the dissociation reaction and the formation, including heat exchange contributions from various fluids and materials in the formation. Contributions may be considered from free water, dissociated gas, dissociated water, and other formation materials (e.g., material adjacent to a hydrate formation). In one embodiment, the energy balance equation is based on the heat provided by the volume flow rate of free water (“Q1”), the heat provided by the volume flow rate of dissociated gas (“Q2”) and the heat provided by the volume flow rate of dissociated water (“Q3”). Other components of the energy balance equation include the heat or energy required to maintain the dissociation reaction and external heat from the formation.

The total energy absorbed or total heat required by the dissociation reaction is calculated in order to estimate the energy balance and determine whether enough energy is present to support the reaction. During the production operation, as the pump operates, free water flows and the bottomhole pressure is lowered. Methane hydrate dissociation starts. The methane hydrate heat absorbing chemical reaction can be represented as:

Methane Hydrate→CH₄+6 H₂O−52 KJ/Mol,

where each mole of methane hydrate dissociation needs about 52,000 joules of heat.

The total heat needed can be calculated based the dissociation reaction according to the following equation:

Total Heat=52000*(Q2*p_gas)/MW_CH₄,

where Q2 is the dissociated gas volume rate (e.g., in units of m3/d), “MW_CH₄” is the methane molar weight (e.g., in units of g/mol), and “p_gas” is the density of the dissociated gas.

The free water taken energy is based on the volume flow rate of free water, Q1. In one embodiment, Q1 is calculated based on production performance data related to the amount of methane produced by the formation or a similar formation. Production performance data may include, for example, production data from previous operations at the same production zone or different production zones in the same borehole. In other examples, production performance can be derived from data collected during production operations at other boreholes in the same formation or in similar formations.

In one embodiment, the production performance data is in the form of a production index (PI), which describes the free water rate as a function of pressure drawdown. The PI or other production performance data is used to calculate parameters of the model and simulation described herein.

Q1 can be calculated based on inflow performance according to the following equation:

Q1=PI*DP,

where “DP” is differential pressure between reservoir pressure and flowing downhole (bottomhole or other interval of a borehole) pressure or drawdown resulting from pumping fluid from the formation.

The dissociated water taken energy is based on the volume flow rate of dissociated water Q3, and the dissociated gas taken energy is based on the volume flow rate of dissociated gas Q2. Q3 can be related to Q2 according to the following chemical reaction formula:

Q3=(6*MW_H₂O/MW_CH₄)*(Q2*p_gas)/p_water,

where “p_water” is the density of water and “MW_H₂O” is the water molar mass (e.g., in units of g/mol).

The heat taken can be calculated from the volume flow rate using a formula that includes the mean fluid specific heat capacity, fluid density and temperature difference between reservoir temperature and the methane equilibrium temperature at the bottomhole pressure.

Calculation of the external energy, in one embodiment, is based on the flow rate of heat (“Qₑₓₜₑᵣₙₐₗ_{_}ₕₑₐₜ”) from the surrounding formation and/or surrounding formation fluid. Calculation of Qₑₓₜₑᵣₙₐₗ_{_}ₕₑₐₜ may be based on the following equation:

Qₑₓₜₑᵣₙₐₗ_{_}ₕₑₐₜ=L_{R}*W*Cₚ*(Tₑᵢ−T_eq)*H,

where “W” is the mass flow rate of formation fluid, “Tₑᵢ” is the formation temperature, “T_eq” is the methane equilibrium temperature at the bottomhole pressure, “L_{R}” is a relaxation parameter, and “H” is reservoir thickness.

L_{R} may be calculated for a borehole section corresponding to a production zone by:

$${L}_{R} = \frac{2 π}{{C}_{p} W} [ \frac{{r}_{to} {U}_{to} {k}_{e}}{{k}_{e} + ( {r}_{to} {U}_{to} {T}_{D} )} ] ,$$

where “Uₜₒ” is the overall heat transfer coefficient for the borehole section, “rₜₒ” is a radius of the wellbore section, “kₑ” is the thermal conductivity of the earth formation and “T_{D}” is a dimensionless temperature.

For simplicity, L_{R} and H can be combined into one factor “ƒ”. Using the factor ƒ Qₑₓₜₑᵣₙₐₗ_{_}ₕₑₐₜ can be represented by:

Qₑₓₜₑᵣₙₐₗ_{_}ₕₑₐₜ=ƒ*W*Cₚ*(Tₑᵢ−T_eq)

The factor ƒ can be calculated from testing data. It is noted that the factor ƒ can be assumed constant in each production zone, but can vary from zone to zone. The factor ƒ can also be a correlation related to reservoir properties such as permeability if the reservoir property data is available. In one embodiment, the factor ƒ can be calculated by comparing a dissociation temperature model to temperature (e.g. DTS) measurements.

The flow rate of dissociated gas Q2 is then calculated according the above energy balance equation, flow rates and input data that includes differential pressure and the temperature of borehole fluid. In one embodiment, the energy balance equation is solved and Q2 is calculated based on a differential temperature representing a difference between the methane hydrate equilibrium temperature at a given pressure and the reservoir temperature.

As discussed above, the temperature of dissociated gas and water vary as pressure changes and the dissociation reaction progresses, and can have different temperatures. The model accounts for this by calculating a temperature differential (“DT”), which is the difference between the borehole fluid entrance temperature (temperature of fluid including mixture of water and gas that enters the borehole) and the temperature of the dissociated gas and water from the P-T methane hydrate equilibrium curve 50.

Borehole entrance temperature can be calculated based on the differential pressure and the Joule-Thomson effect (C₁) according to the following equation:

$$- {C}_{p} {C}_{J} = \frac{x * T}{z {ρ}_{s}} {( \frac{dz}{dT} )}_{p} - ( 1 - x ) ( 1 - T * β ) / {ρ}_{L} ,$$

where “Cₚ” is a mean specific heat capacity of the borehole fluid at constant pressure, “x” is the mass fraction of gas in the fluid entering the borehole, T is the temperature of the fluid mixture entering the borehole (e.g., measured temperature or DTS measurement), “z” is gas compressibility factor, “β” is a water volume expansion factor of 1/° F., “p” is a fluid pressure, “ρ_{g}” is gas density and “ρ_{L}” is water density, and “(dZ/dT)ₚ” is a gas compressibility factor at two different temperatures at a constant pressure p.

For water, x=0 and the equation reduces to:

−CₚC_{J}=−(1−T*β)/ρ_{L}

For gas, x=1 and the equation reduces to:

$$- {C}_{p} {C}_{J} = \frac{T}{z {ρ}_{s}} {( \frac{dz}{dT} )}_{p}$$

By definition, C_{J}=DT/DP, so the borehole entrance temperature for gas and the borehole entrance temperature for water is T_entry=T_eq−Cⱼ*DP. Where T_eq is the methane equilibrium temperature at the bottomhole pressure.

A simulation method is provided that involves applying the model to predict the temperature and volumetric flow rate of free water, dissociated methane gas and dissociated water from a methane hydrate formation. The method includes: (1) calculating production index and external heat factor based on production performance data; (2) solving energy balance to obtain free water volume rate, dissociated gas and dissociated water volume rates as a function of bottomhole pressure and (3) calculating water and gas temperature entering into the borehole as a function of bottomhole pressure based on the Joule-Thomson effect.

The simulation method may be performed via suitable software such as a multiphase flow simulator or other simulation program using the energy balance equation and model discussed above. The model may also be calibrated based on measured data. For example, model predictions can be generated as a data structure (e.g., as a table) that correlate water and gas flow rates and temperatures as a function of downhole pressure. The data structure can then be input to a dynamic simulator.

It is noted that the predictions can be performed prior to or during the production operation. In addition, the predictions can also be performed after the production operation and compared to production data for calibration purposes. For example, predictions may be performed prior to performing a production operation based on anticipated or expected conditions and operational parameters (e.g., expected drawdown). In another example, predictions can be performed during an operation to monitor the operation and adjust operational parameters as needed to avoid plugging and improve methane gas production. The predictions and model may be updated continuously or periodically during an operation based on real time temperature and pressure measurements.

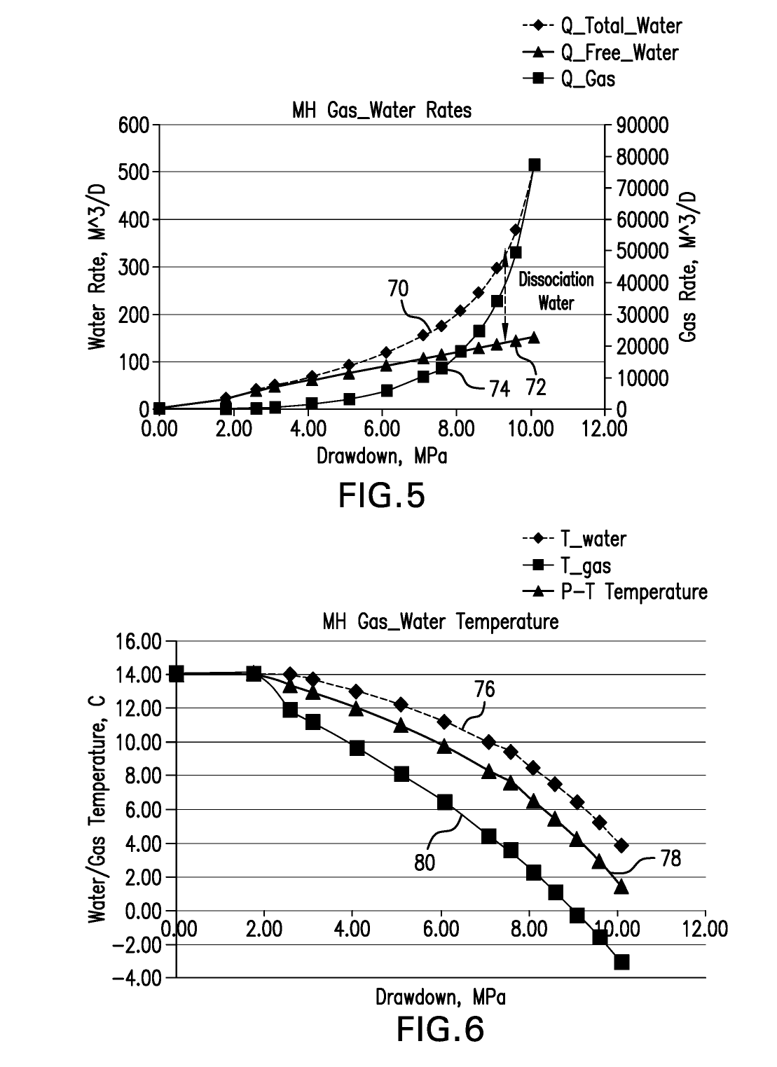

FIGS. 5 and 6 show an example of prediction results generated according to the model and method discussed above. FIG. 5 is a flow rate plot that shows predicted flow rates as a function of drawdown pressure. Curve 70 is a plot of total water volume flow rates, curve 72 is a plot of free water flow rates, and curve 74 is a plot of dissociated methane gas flow rates. It is noted that the difference between Curve 70 and Curve 72 is the dissociated water volume rates.

The results show the different flow rates or production responses of methane and water. As shown, the higher the drawdown, the higher the flow rate. For example, at a drawdown of 8 MPa, the total water flow rate is about 205 cubic meters per day (m³/d) and the dissociated gas flow rate is about 18,100 m³/d. Increasing the drawdown to 9 MPa results in the total water flow rate increasing to about 300 m³/d. What is not evident from the total water flow rate, but is revealed by the model is that the same increase almost doubles the gas flow rate to about 34,200 m³/d. This result provides valuable information to an operator to allow the operator to make the most appropriate decision regarding drawdown selection.

FIG. 6 is a temperature plot that shows the relationship between temperature entering into the borehole and drawdown. Curve 76 is a plot of water temperature, curve 78 is a plot of temperature from P-T methane hydrate equilibrium curve at various bottomhole pressure, and curve 80 is a plot of methane gas temperature as a function of drawdown.

As drawdown increases, the temperature lowers, which puts a limit on how much drawdown can be employed. Due to the ratio of the gas and water being different at different locations, the mixing temperature will be different. Knowledge of this ratio provides valuable information as to the amount of gas that is being produced at a given production zone or location.

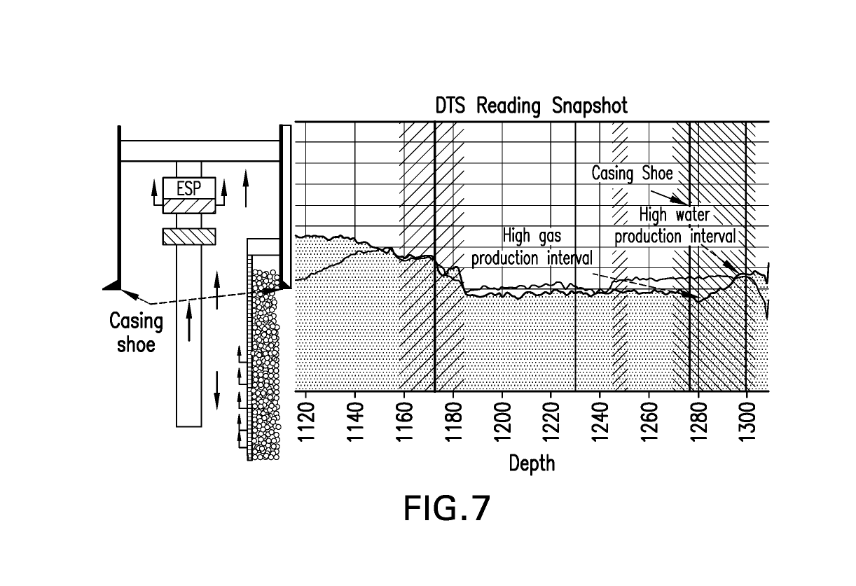

Using the temperature information, the differential temperature between water and gas can be predicted. As shown in FIG. 7, which is an example of a temperature distribution plot, the temperature varies along the length of a borehole and/or production zone. Using the model discussed herein, the combination of gas and water and the distribution of gas along the borehole can be predicted.

As demonstrated by FIG. 7, accounting for the mixing of the two temperatures from gas and water at one pressure provides a more accurate representation of the downhole environment. In addition, as shown in FIG. 7, different intervals can have different mixtures of gas and water within the same production zone, which can be identified by looking at the temperature distribution. At each interval, there may be a different rate and a different temperature, as well as a different proportion of gas and water, so the flow rate and temperature prediction provides information to determine how much gas there is relative to water.

Set forth below are some embodiments of the foregoing disclosure:

Embodiment 1. A system for predicting production parameters, comprising: a production assembly configured to be disposed along a length of a borehole, the production assembly configured to receive fluid from a region of an earth formation hat includes a methane hydrate deposit, the fluid including methane gas dissociated from the deposit and water dissociated from the deposit; and a processor configured to receive data including a temperature and a pressure of the fluid, the processor configured to perform: generating a mathematical model based on an energy balance relationship that includes an amount of energy estimated to be used by a dissociation reaction that produces dissociated water and dissociated gas, the energy balance relationship accounting for a first amount of energy taken by the dissociated water and a second amount of energy taken by the dissociated gas, the energy balance relationship based on the temperature of the fluid and the pressure of the fluid; and predicting a flow rate of the dissociated gas as a function of a pressure differential in the borehole based on the model.

Embodiment 2. The system of any prior embodiment, further comprising a pumping assembly configured to control fluid pressure in the borehole and the region, the processor configured to control the pumping assembly based on the predicted flow rate of the dissociated gas.

Embodiment 3. The system of any prior embodiment, wherein the energy balance relationship further accounts for a third amount of energy taken by free water entering the borehole and a fourth amount of external energy provided by the formation.

Embodiment 4. The system of any prior embodiment, wherein the received data includes an inflow performance indicator related to methane production performance derived from previous operations, the energy taken by the free water estimated based on the inflow performance indicator and the pressure of the fluid.

Embodiment 5. The system of any prior embodiment, wherein the energy balance relationship is based on a differential temperature estimated based on a difference between a temperature of methane hydrate equilibrium and a reservoir temperature.

Embodiment 6. The system of any prior embodiment, wherein the borehole entrance temperature is estimated based on a Joule-Thomson coefficient.

Embodiment 7. The system of any prior embodiment, wherein predicting includes generating flow rate information indicating the flow rate of the dissociated gas as a function of a pressure differential in the borehole, and generating separate flow rate information indicating a flow rate of the dissociated water as a function of the pressure differential.

Embodiment 8. The system of any prior embodiment, wherein the processor is further configured to predict a temperature of the dissociated gas as a function of the pressure differential.

Embodiment 9. The system of any prior embodiment, wherein predicting includes generating separate temperature information indicating a temperature of the dissociated water as a function of the pressure differential.

Embodiment 10. The system of any prior embodiment, wherein the processor is configured to predict a distribution of the flow rate of the dissociated gas along one or more production zones of the borehole.

Embodiment 11. A method of predicting production parameters, comprising: receiving data related to a methane production operation, the data including a temperature and a pressure of fluid entering a borehole from a methane hydrate deposit, the fluid including methane gas dissociated from the deposit and water dissociated from the deposit; and generating, by a processor, a mathematical model based on an energy balance relationship that includes an amount of energy estimated to be used by a dissociation reaction that produces dissociated water and dissociated gas, the energy balance relationship accounting for a first amount of energy taken by the dissociated water and a second amount of energy taken by the dissociated gas, the energy balance relationship based on the temperature of the fluid and the pressure of the fluid; predicting a flow rate of the dissociated gas as a function of a pressure differential in the borehole based on the model; and selecting an operational parameter based on the predicted flow rate.

Embodiment 12. The method of any prior embodiment, wherein the operational parameter includes a pressure drawdown value applied by a pumping assembly configured to control fluid pressure in the borehole and the region.

Embodiment 13. The method of any prior embodiment, wherein the energy balance relationship further accounts for a third amount of energy taken by free water entering the borehole and a fourth amount of external energy provided by the formation.

Embodiment 14. The method of any prior embodiment, wherein the received data includes an inflow performance indicator related to methane production performance derived from previous operations, the energy taken by the free water estimated based on the inflow performance indicator and the pressure of the fluid.

Embodiment 15. The method of any prior embodiment, wherein the energy balance relationship is based on a differential temperature estimated based on a difference between a temperature of methane hydrate equilibrium and a reservoir temperature.

Embodiment 16. The method of any prior embodiment, wherein the borehole fluid entrance temperature differential temperature is estimated based on a Joule-Thomson coefficient.

Embodiment 17. The method of any prior embodiment, wherein predicting includes generating flow rate information indicating the flow rate of the dissociated gas as a function of a pressure differential in the borehole, and generating separate flow rate information indicating a flow rate of the dissociated water as a function of the pressure differential.

Embodiment 18. The method of any prior embodiment, further comprising predicting a temperature of the dissociated gas as a function of the pressure differential.

Embodiment 19. The method of any prior embodiment, wherein predicting includes generating separate temperature information indicating a temperature of the dissociated water as a function of the pressure differential.

Embodiment 20. The method of any prior embodiment, further comprising predicting a distribution of the flow rate of the dissociated gas along one or more production zones of the borehole.

Generally, some of the teachings herein are reduced to an algorithm that is stored on machine-readable media. The algorithm is implemented by a computer or processor such as the processing unit 36 and provides operators with desired output. For example, data may be transmitted in real time from a downhole sensor to the surface processing unit 36 for processing.

In support of the teachings herein, various analyses and/or analytical components may be used, including digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing aspects of the teachings herein. For example, a sample line, sample storage, sample chamber, sample exhaust, pump, piston, power supply (e.g., at least one of a generator, a remote supply and a battery), vacuum supply, pressure supply, refrigeration (i.e., cooling) unit or supply, heating component, motive force (such as a translational force, propulsional force or a rotational force), magnet, electromagnet, sensor, electrode, transmitter, receiver, transceiver, controller, optical unit, electrical unit or electromechanical unit may be included in support of the various aspects discussed herein or in support of other functions beyond this disclosure.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A system for predicting production parameters, comprising:
a production assembly configured to be disposed along a length of a borehole, the production assembly configured to receive fluid from a region of an earth formation that includes a methane hydrate deposit, the fluid including methane gas dissociated from the deposit and water dissociated from the deposit; and
a processor configured to receive data including a temperature and a pressure of the fluid, the processor configured to perform:
generating a mathematical model based on an energy balance relationship that includes an amount of energy estimated to be used by a dissociation reaction that produces dissociated water and dissociated gas, the energy balance relationship accounting for a first amount of energy taken by the dissociated water and a second amount of energy taken by the dissociated gas, the energy balance relationship based on the temperature of the fluid and the pressure of the fluid; and
predicting a flow rate of the dissociated gas as a function of a pressure differential in the borehole based on the model.

2. The system of claim 1, further comprising a pumping assembly configured to control fluid pressure in the borehole and the region, the processor configured to control the pumping assembly based on the predicted flow rate of the dissociated gas.

3. The system of claim 1, wherein the energy balance relationship further accounts for a third amount of energy taken by free water entering the borehole and a fourth amount of external energy provided by the formation.

4. The system of claim 3, wherein the received data includes an inflow performance indicator related to methane production performance derived from previous operations, the energy taken by the free water estimated based on the inflow performance indicator and the pressure of the fluid.

5. The system of claim 3, wherein the energy balance relationship is based on a differential temperature estimated based on a difference between a temperature of methane hydrate equilibrium and a reservoir temperature.

6. The system of claim 5, wherein the borehole entrance temperature is estimated based on a Joule-Thomson coefficient.

7. The system of claim 1, wherein predicting includes generating flow rate information indicating the flow rate of the dissociated gas as a function of a pressure differential in the borehole, and generating separate flow rate information indicating a flow rate of the dissociated water as a function of the pressure differential.

8. The system of claim 1, wherein the processor is further configured to predict a temperature of the dissociated gas as a function of the pressure differential.

9. The system of claim 8, wherein predicting includes generating separate temperature information indicating a temperature of the dissociated water as a function of the pressure differential.

10. The system of claim 1, wherein the processor is configured to predict a distribution of the flow rate of the dissociated gas along one or more production zones of the borehole.

11. A method of predicting production parameters, comprising:
receiving data related to a methane production operation, the data including a temperature and a pressure of fluid entering a borehole from a methane hydrate deposit, the fluid including methane gas dissociated from the deposit and water dissociated from the deposit; and
generating, by a processor, a mathematical model based on an energy balance relationship that includes an amount of energy estimated to be used by a dissociation reaction that produces dissociated water and dissociated gas, the energy balance relationship accounting for a first amount of energy taken by the dissociated water and a second amount of energy taken by the dissociated gas, the energy balance relationship based on the temperature of the fluid and the pressure of the fluid;
predicting a flow rate of the dissociated gas as a function of a pressure differential in the borehole based on the model; and
selecting an operational parameter based on the predicted flow rate.

12. The method of claim 11, wherein the operational parameter includes a pressure drawdown value applied by a pumping assembly configured to control fluid pressure in the borehole and the region.

13. The method of claim 11, wherein the energy balance relationship further accounts for a third amount of energy taken by free water entering the borehole and a fourth amount of external energy provided by the formation.

14. The method of claim 13, wherein the received data includes an inflow performance indicator related to methane production performance derived from previous operations, the energy taken by the free water estimated based on the inflow performance indicator and the pressure of the fluid.

15. The method of claim 13, wherein the energy balance relationship is based on a differential temperature estimated based on a difference between a temperature of methane hydrate equilibrium and a reservoir temperature.

16. The method of claim 15, wherein the borehole fluid entrance temperature differential temperature is estimated based on a Joule-Thomson coefficient.

17. The method of claim 1, wherein predicting includes generating flow rate information indicating the flow rate of the dissociated gas as a function of a pressure differential in the borehole, and generating separate flow rate information indicating a flow rate of the dissociated water as a function of the pressure differential.

18. The method of claim 11, further comprising predicting a temperature of the dissociated gas as a function of the pressure differential.

19. The method of claim 18, wherein predicting includes generating separate temperature information indicating a temperature of the dissociated water as a function of the pressure differential.

20. The method of claim 11, further comprising predicting a distribution of the flow rate of the dissociated gas along one or more production zones of the borehole.
